(19) United States
(12) Patent Application Publication
(10) Pub. No.: US 2024/0038252 A1
(43) Pub. Date: Feb. 1, 2024

(54) SOUND SIGNAL PROCESSING METHOD AND APPARATUS, AND ELECTRONIC DEVICE

(71) Applicant: BEIJING YOUZHUJU NETWORK TECHNOLOGY CO. LTD., Beijing (CN)

(72) Inventors: Wenzhi FAN, Beijing (CN); Fanliu KONG, Beijing (CN); Yangfei XU, Beijing (CN); Zhifei ZHANG, Beijing (CN)

(21) Appl. No.: 18/256,285

(22) PCT Filed: Dec. 3, 2021
(86) PCT No.: PCT/CN2021/135398

§ 371 Date: Jun. 7, 2023

(30) Foreign Application Priority Data
Dec. 8, 2020 (CN) 202011462091.2

(51) Int. Cl. G10L 21/02; G10L 25/27

(52) U.S. Cl. CPC G10L 21/02; G10L 25/27

(57) ABSTRACT

A sound signal processing method, an electronic device, and computer-readable medium are provided. The method includes: importing first frequency spectrum data corresponding to first audio data into a pre-trained sound processing model to obtain a processing result; and generating, based on the processing result, pure audio data corresponding to the first audio data. The sound processing model includes at least one preset convolution layer, and operations performed by using the preset convolution layer includes: performing, based on a first convolution kernel group, a convolution operation on a first sound spectrum feature map inputted into the preset convolution layer, to obtain a second sound spectrum feature map; and combining, based on a second convolution kernel group, the obtained second sound spectrum feature map, to obtain a third sound spectrum feature map corresponding to the second convolution kernel group.

The present application is the national phase application of PCT International Patent Application No. PCT/CN2021/135398, filed on Dec. 3, 2021 which claims the priority to Chinese Patent Application No. 202011462091.2, titled “SOUND SIGNAL PROCESSING METHOD AND APPARATUS, AND ELECTRONIC DEVICE”, filed on Dec. 8, 2020 with the Chinese Patent Office, both of which are incorporated herein by reference in their entireties.

### FIELD

The present disclosure relates to the technical field of internet, and in particular to a sound signal processing method, a sound signal processing apparatus, and an electronic device.

### BACKGROUND

With the development of the internet, more and more users use terminal devices to implement various functions. For example, in applications such as an application for daily communication and an intelligent voice interaction system, a terminal needs to collect sound signals. The collected sound signal contains various noises, such as environmental noise and noise from other interfering sound sources. In the communication application, noises reduce the clarity and intelligibility of speeches, seriously affecting the quality of calls. In the intelligent human-machine interaction system, noises significantly reduce the recognition rate of the speech recognition system, seriously affecting the user's experience.

### SUMMARY

This summary is provided to introduce the idea in a simplified form. The idea will be described in detail in the following description. This summary is neither intended to identify key features or essential features of the claimed technical solution, nor intended to be used to limit the scope of the claimed technical solution.

In a first aspect, a sound signal processing method is provided, including: importing first frequency spectrum data corresponding to first audio data into a pre-trained sound processing module, to obtain a processing result; and generating, based on the processing result, pure audio data corresponding to the first audio data. The sound processing model includes at least one preset convolution layer, and operations performed by using the preset convolution layer includes: performing, based on a first convolution kernel group, a convolution operation on a first sound spectrum feature map inputted into the preset convolution layer, to obtain a second sound spectrum feature map; and combining, based on a second convolution kernel group, the obtained second sound spectrum feature map, to obtain a third sound spectrum feature map corresponding to the second convolution kernel group.

In a second aspect, a sound signal processing apparatus is provided, including: a first generation unit configured to import first frequency spectrum data corresponding to first audio data into a pre-trained sound processing module, to obtain a processing result; and a second generation unit is configured to generate, based on the processing result, pure audio data corresponding to the first audio data. The sound processing model includes at least one preset convolution layer, and operations performed by using the preset convolution layer includes: performing, based on a first convolution kernel group, a convolution operation on a first sound spectrum feature map inputted into the preset convolution layer, to obtain a second sound spectrum feature map; and combining, based on a second convolution kernel group, the obtained second sound spectrum feature map, to obtain a third sound spectrum feature map corresponding to the second convolution kernel group.

In a third aspect, an electronic device is provided, including: one or more processors; and a storage device configured to store one or more programs, where the one or more programs, when executed by the one or more processors, cause the one or more processors to implement the sound signal processing method according to the first aspect.

In a fourth aspect, a computer-readable medium, on which a computer program is stored is provided, where the program is configured to implement the sound signal processing method according to the first aspect when executed by a processor.

### BRIEF DESCRIPTION OF THE DRAWINGS

The above and other features, advantages and aspects of various embodiments of the present disclosure will become more apparent when taken in conjunction with the accompanying drawings and with reference to the following detailed description. Throughout the drawings, the same or similar reference numbers refer to the same or similar elements. It should be understood that the drawings are schematic and that the components and elements are not necessarily drawn to scale.

FIG. 1 is a flowchart of a sound signal processing method according to an embodiment of the present disclosure;

FIG. 2 is a flow chart showing an operation flow performed by using a preset convolution layer;

FIG. 3 is a schematic diagram of an exemplary sound spectrum feature;

FIG. 4 is a schematic diagram showing an exemplary flow of step 201;

FIG. 5 is a schematic diagram showing an exemplary flow of of step 202;

FIG. 6 is a schematic diagram of an exemplary scenario of step 201;

FIGS. 7A and 7B are schematic diagrams of exemplary scenarios of step 202;

FIGS. 8A and 8B are schematic diagrams of exemplary scenarios of changes of a perception field;

FIG. 9 is a schematic structural diagram of a sound signal processing apparatus according to an embodiment of the present disclosure;

FIG. 10 a schematic structural diagram of an exemplary system architecture to which a sound signal processing method according to an embodiment of the present disclosure is applicable; and

FIG. 11 is a schematic diagram of a basic structure of an electronic device according to an embodiment of the present disclosure.

### DETAILED DESCRIPTION OF THE EMBODIMENTS

Embodiments of the present disclosure will be described in more detail below with reference to the accompanying drawings. While certain embodiments of the present disclosure are shown in the drawings, it should be understood that the present disclosure may be embodied in various forms and should not be construed as limited to the embodiments set forth herein. Instead, the embodiments are provided for the purpose of a more thorough and complete understanding of the present disclosure. It should be understood that the drawings and embodiments of the present disclosure are only for exemplary purposes, and are not intended to limit the scope of the present disclosure.

It should be understood that the various steps described in the method embodiments of the present disclosure may be performed in different orders and/or in parallel. Furthermore, method embodiments may include additional steps and/or omit performing the illustrated steps. The scope of the present disclosure is not limited in this regard.

As used herein, the term “including” and variations thereof are open-ended inclusions, that is, “including but not limited to”. The term “based on” means “based at least in part on.” The term “one embodiment” means “at least one embodiment”; the term “another embodiment” means “at least one additional embodiment”; the term “some embodiments” means “at least some embodiments”. Relevant definitions of other terms will be given in the description below.

It should be noted that concepts such as “first” and “second” mentioned in the present disclosure are only used to distinguish different devices, modules or units, and are not used to limit the order or interdependence of functions performed by these devices, modules or units.

It should be noted that the modifications of “a” and “a plurality” mentioned in the present disclosure are illustrative rather than restrictive, and those skilled in the art should understand that unless the context clearly indicates otherwise, they should be understood as “one or multiple”.

The names of messages or information exchanged between multiple devices in the embodiments of the present disclosure are only for illustrative purposes, and are not intended to limit the scope of these messages or information.

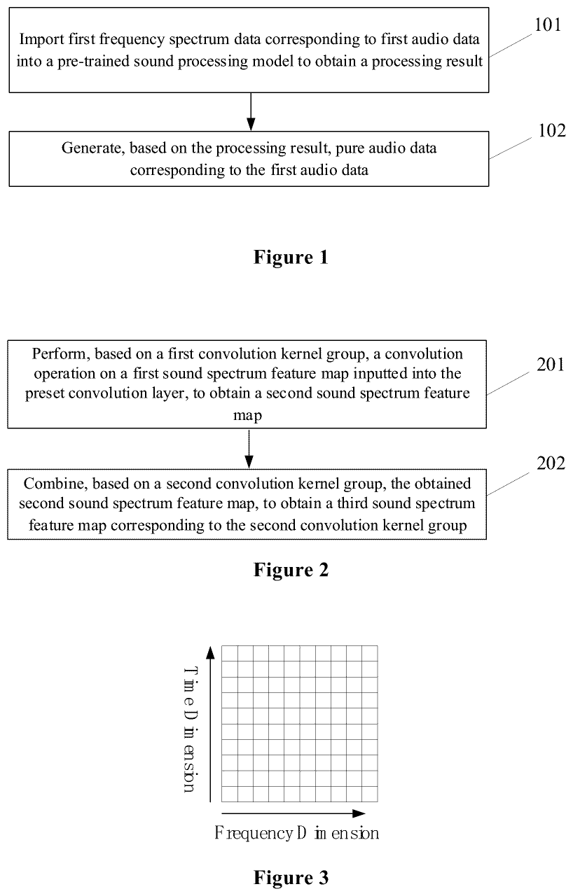

Reference is made to FIG. 1, which shows a flow a sound signal processing method according to an embodiment of the present disclosure. The sound signal processing method is applicable to a terminal device. As shown in FIG. 1, the sound signal processing method includes the following steps 101 and 102.

In step 101, first frequency spectrum data corresponding to first audio data is imported into a pre-trained sound processing model to obtain a processing result.

In this embodiment, the executing subject of the sound signal processing method (for example, a terminal device) may import the first frequency spectrum data corresponding to the first audio data into the pre-trained sound processing model to obtain the processing result.

In this embodiment, the first audio data may be a digital sound signal. Generally, an analog sound signal may be converted into a digital sound signal.

In some application scenarios, the first audio data may be a time-domain signal, and for the convenience of processing, time-frequency conversion may be performed on the first audio data to obtain the first frequency spectrum data. Here, the manner for performing the time-frequency transformation may be set according to actual application scenarios, and is not limited here.

In some application scenarios, the first frequency spectrum data may form a two-dimensional matrix, where one dimension of the matrix represents the frequency dimension, another dimension of the matrix represents the time dimension, and a matrix element value in the matrix represents a frequency amplitude.

As an example, for time-frequency transformation of audio data having a duration of 2 seconds, the original signal (the time domain signal of 2 seconds) may be framed and windowed, to obtain multiple frames, and FFT (Fast Fourier Transformation) may be performed on each frame to convert the time-domain signal into a frequency-domain signal, and frequency-domain signals (spectrograms) obtained by performing FFT on the multiples frames may be stacked in the time domain to obtain a sonogram, which may be understood as an intuitive interpretation of the first frequency spectrum data.

In step 102, pure audio data corresponding to the first audio data is generated based on based on the processing result.

In this embodiment, the execution subject may generate the pure audio data corresponding to the first audio data based on the processing result.

In this embodiment, a data item included in the processing result may be set according to actual application scenarios, and are not limited here. In step 102, the pure audio data corresponding to the first audio data may be generated according to the data item included in the processing result in a manner suitable for the data item.

In this embodiment, the sound processing model may be pre-trained. In other words, the parameter of the sound processing model may be predetermined through training.

In this embodiment, the sound processing model may include at least one preset convolution layer.

In this embodiment, the number of the preset convolutional layer in the sound processing model may be set according to actual application scenarios, and is not limited here. It should be understood that the sound processing model may further include other types of network layers according to actual application scenarios.

In this embodiment, referring to FIG. 2, an operation flow performed by using the preset convolution layer includes following steps 201 and 202.

In step 201, a convolution operation is performed on a first sound spectrum feature map inputted into the preset convolution layer based on a first convolution kernel group, to obtain a second sound spectrum feature map.

In this embodiment, each first convolution kernel group corresponds to one first sound spectrum feature map inputted to the preset convolution layer.

In some embodiments, the number of the first convolution kernel set matches the number of the first spectral feature map inputted into the preset convolution layer.

Step 202, the obtained second sound spectrum feature map is combined based on a second convolution kernel group, to obtain a third sound spectrum feature map corresponding to the second convolution kernel group.

In some embodiments, the number of the second convolution kernel group matches the number of an output channel.

Reference is made to FIG. 3, which shows an exemplary sound spectrum feature map. FIG. 3 exemplarily marks the frequency dimension and time dimension of the sound spectrum feature map.

In this embodiment, the first frequency spectrum data may be understood as an original spectrogram. The sound spectrum feature map may be obtained by performing feature extraction on the original spectrogram by using the first preset convolution layer of the sound processing model. The sound spectrum feature map is inputted into a preset convolution layer subsequent to the first preset convolution, and the output may also be referred to as a sound spectrum feature map.

For the convenience of description, a preset convolutional layer is taken as an example in the present disclosure for description. The input of the preset convolution layer may be referred to as the first sound spectrum feature map. (The original spectrogram may also understand as a sound spectrum feature map)

In this embodiment, the preset convolution layer may include at least two first convolution kernel groups. The first convolution kernel groups are in one-to-one correspondence with the first sound spectrum feature maps. In other words, each first convolution kernel group may process one of the first sound spectrum feature maps to obtain a second sound spectrum feature map.

In this embodiment, the first convolution kernel group may include one or more the convolution kernels.

In this embodiment, the calculation of each second convolution kernel group involves all second spectral feature maps, and the calculation result of each second convolution kernel group may be determined as an output of the preset convolution layer.

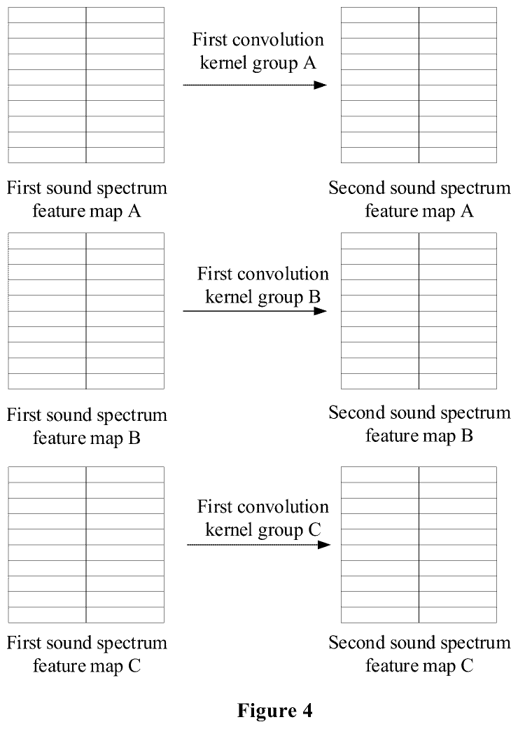

Referring to FIG. 4, which shows a schematic diagram of step 201. The input of the preset convolution layer may have 3 channels, including a first sound spectrum feature map A, a first sound spectrum feature map B, and a first sound spectrum feature map C. The number of the first convolution kernel group may be the same as the number of input channels, that is, the number of the first convolution kernel group may be three. Each first convolution kernel group may have a corresponding first sound spectrum feature map. Specifically, a first convolution kernel group A may perform convolution on the first sound spectrum feature map A to obtain a second sound spectrum feature map A; a first convolution kernel group B may perform convolution on the first sound spectrum feature map B to obtain a second sound spectrum feature map B; and a first convolution kernel group C may perform convolution on the first sound spectrum feature map C to obtain a second sound spectrum feature map C.

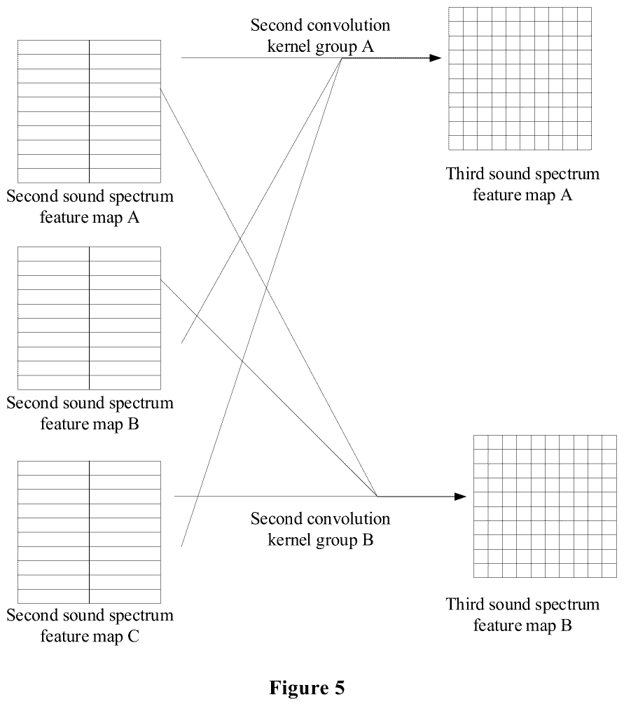

Reference is made to FIG. 5, which shows a schematic diagram of step 202. The preset convolutional layer may have 2 output channels. The number of the second convolution kernel group may be the same as the number of the output channel, that is, the number of the second convolution kernel group is two. A second convolution kernel group A may combine the second sound spectrum feature map A, the second sound spectrum feature map B, and the second sound spectrum feature map C to obtain a third sound spectrum feature map A. A second convolution kernel group B may combine the second sound spectrum feature map A, the second sound spectrum feature map B, and the second sound spectrum feature map C to obtain a third sound spectrum feature map B.

In some application scenarios, the second convolution kernel in the second convolution kernel group may be a three-dimensional convolution kernel. The depth of the second convolution kernel may be the same as the number of the second sound spectrum feature map.

It should be noted that, in the sound signal processing method according to this embodiment, first frequency spectrum data is processed by using a sound processing model including at least one preset convolution layer to obtain a processing result, and pure audio data is obtained based on the processing result, such that the calculation amount consumed to obtain pure audio data can be reduced, and the processing speed can be improved.

A comparative analysis is provided as follows. If the step size of the convolution is 1, the number of multiplication calculations for a single preset convolution layer in the present disclosure is C1+C2. C1 is the multiplication calculation amount in step 201 which equals to the length of the first convolution kernel*the width of the first convolution kernel*the length of the frequency dimension*the length of the time dimension*the number of the input channels. C2 is the multiplication calculation amount in step 201, which equals to the number of the input channels*the length of the frequency dimension*the length of the time dimension*the number of the output channels. It should be understood that the size of the second convolution kernel is generally 1*1*the number of the input channels when performing combination. In related technologies, the number of multiplication calculations of the convolutional layer in normal circumstances is C3 which equals to the number of the input channels*the length of the frequency dimension*the length of the time dimension*the length of the first convolution kernel*the width of the first convolution kernel*the number of the output channels. Based on the above, it can be concluded that, with the method according to the present disclosure, the calculation amount can be greatly reduced, so that the calculation resources consumed by the sound processing model to process the sound signal are greatly reduced.

In some embodiments, the above sound processing model is provided on a terminal device.

It should be noted that, with the audio signal processing method according to some embodiments of the present disclosure, the calculation amount can be reduced while ensuring better processing accuracy, that is, having better noise suppression effects. Due to the small calculation amount, the method and the sound processing model according to some embodiments of the present disclosure are suitable for implementation on a terminal device. By implementing the sound processing model according to some embodiments of the present disclosure in the terminal device, collected sounds can be processed in a real-time manner, which not only improves the user's sound experience, but also reduces the amount of data transmission in remote interaction tasks.

In some embodiments, the first convolution kernel group includes at least two first convolution kernels.

In some embodiments, the above step 201 may include: performing, according to a first correspondence, the convolution operation on the first sound spectrum feature map by using the first convolution kernels in the first convolution kernel group, to obtain the second sound spectrum feature map.

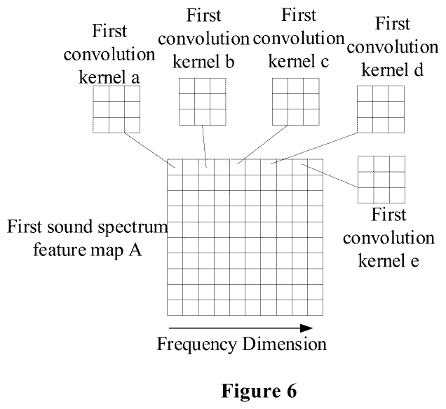

Here, the first correspondence indicates a correspondence between the first convolution kernel and a frequency of the first sound spectrum feature map. For example, referring to FIG. 6, on the frequency dimension of the first sound spectrum feature map A, a first convolution kernel may be set every other frequency. Specifically, a first convolution kernel a, a first convolution kernel b, a first convolution kernel c, a first convolution kernel d, and a first convolution kernel e may be set.

It should be understood that the number of convolution kernels in the first convolution kernel group may be set according to actual application scenarios, and is not limited here.

In this embodiment, the first convolution kernels in the first convolution kernel group may have the same size and different weights. The weight of each first convolution kernel may be learned through adjustment during the training of the sound processing model.

It should be noted that by setting the first convolution kernel group including at least two first convolution kernels, a different convolution kernel is learned for a different frequency dimension of the output, which increases the amount of network parameters and does not increase the calculation amount. Therefore, the processing accuracy of the sound processing model can be improved while ensuring the processing efficiency.

In some embodiments, the second convolution kernel group includes at least two second convolution kernels.

In some embodiments, the above step 204 may include: combining, according to a second correspondence, the obtained second sound spectrum feature map by using the second convolution kernels in the second convolution kernel group, to obtain the third sound spectrum feature map corresponding to the second convolution kernel group.

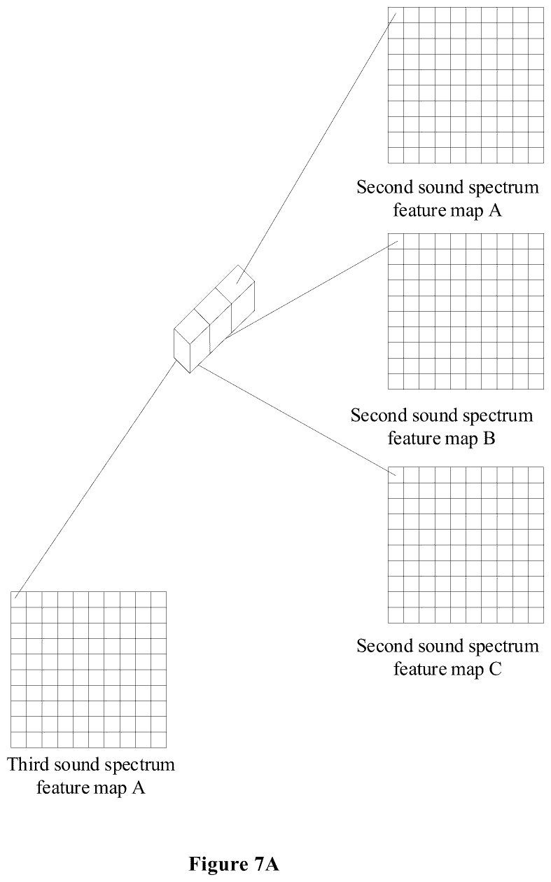

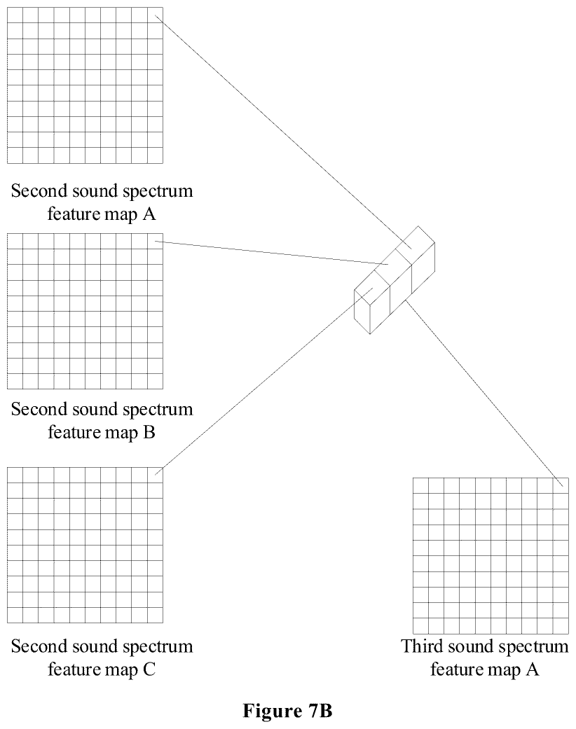

Here, the second correspondence indicates a correspondence between the second convolution kernel and a frequency of the second sound spectrum feature map. For example, reference is made to FIGS. 7A and 7B.

FIG. 7A shows a second convolution kernel f corresponding to a first frequency in the frequency dimension. The second convolution kernel f may combine (for example, take the weighted sum of) values at the same position (that is, the first row and the first column) of the second sound spectrum feature map A, the second sound spectrum feature map B, and the second sound spectrum feature map C, to obtain a value at the corresponding position (i.e., the first row and the first column) of the third sound spectrum feature map A.

FIG. 7B shows a second convolution kernel g corresponding to the first frequency in the frequency dimension. The second convolution kernel g may combine (for example, take the weighted sum of) values at the same position (that is, the first row and the last column) of the second sound spectrum feature map A, the second sound spectrum feature map B, and the second sound spectrum feature map C, to obtain a value at the corresponding position (i.e., the first row and the last column) of the third sound spectrum feature map A.

It should be understood that the second convolution group A may include the second convolution kernel f and the second convolution kernel g, and may further include second convolution kernels corresponding to other frequencies of the frequency dimension of the second sound spectrum feature map.

It should be noted that by setting the second convolution kernel group including at least two second convolution kernels, different convolution kernels can be learned for different frequencies, increasing the amount of network parameters without increasing the amount of calculation. Therefore, the processing accuracy of the sound processing model can be improved while ensuring the processing efficiency.

In some embodiments, the number of convolution kernels in the first convolution kernel group is determined according to a length of the frequency dimension of the first sound spectrum feature map and a step size.

Here, the step size may be used to characterize the sparsity of the convolution operation. As an example, referring to FIG. 6, the length of the frequency dimension is 10, the step size is 2, and the number of convolution kernels is 5. If the step size in FIG. 6 is changed to 1, the number of convolution kernels may be 10.

In some embodiments, the number of convolution kernels in the first convolution kernel group is the same as the length of the frequency dimension.

It should be noted that setting the step size as the basis for adjusting the number of convolution kernels can reduce the number of calculations and improve processing efficiency.

In some embodiments, a receptive field of the first convolution kernel is determined based on a sampling position and a preset position offset parameter.

Here, the receptive field of the first convolution kernel may be determined based on a candidate sampling position and the preset position offset parameter.

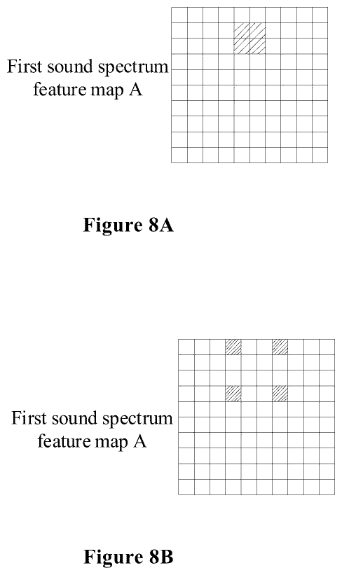

As an example, referring to FIGS. 8A and 8B, which are schematic diagrams showing examples of changes of the receptive field. During the calculation by the first convolution kernel, the candidate sampling position of the convolution kernel is shown by the shaded part in FIG. 8A; if the set position offset parameter indicates that the sampling position is changed based on the candidate sampling position, for example, change to the position of the shaded part shown in FIG. 8B, the final receptive field of the convolution kernel is the position of the shaded part in FIG. 8B.

It should be noted that through the change of the receptive field, a large receptive field can be obtained without changing the number of parameters and the calculation cost. In this way, the processing accuracy can be improved while ensuring the processing efficiency.

In some embodiments, the sound processing model includes at least one self-attention layer, and the self-attention layer is arranged subsequent to the at least one preset convolution layer.

Here, the operation performed by the self-attention layer include: for each sound spectrum feature map output by the preset convolution layer, re-evaluate, based on a value of each position in the sound spectrum feature map and values of other positions in the sound spectrum feature map, the value of the position.

It should be noted that, in a case that the self-attention layer re-evaluates the value of each position of the sound spectrum feature map, the implementation of the self-attention layer can be set according to the actual application scenario, and is not limited here.

It should be noted that by setting the self-attention layer, the processing results, especially the processing results of masked data, can be made more accurate.

In some embodiments, the sound processing model described above includes mask data, which is also referred to as masking data, and is used to extract a target signal from a mixed signal. For example, in a mixed signal in which a speech signal is mixed with background noise, a mask signal is used to process the mixed signal, to extract the speech signal from the mixed signal.

In general, the spectrogram corresponding to the pure speech data may be obtained by multiplying corresponding positions of the mask data and the spectrogram corresponding to the mixed signal.

In some embodiments, the above step 102 may include generating second frequency spectrum data based on the mask data and the first frequency spectrum data; and converting the second frequency spectrum data into time domain data to obtain the pure audio data.

In some application scenarios, the product of the first frequency spectrum data and the mask data may be used as the second frequency spectrum data.

In some embodiments, the sound processing model of which the output includes the mask data may be trained in the following manner: obtaining a mixed audio sample; importing the mixed audio sample into an untrained sound processing model to generate candidate mask data; generating a first loss value based on a label of the mixed audio sample and the candidate masking data; and adjusting, based on the first loss value, a parameter of the untrained sound processing model.

Here, the label of the training sample is generated by: performing time-frequency transformation on a pure audio sample and the mixed audio sample separately, generating mask data for training based on data obtained through the transformation, and determining the mask data for training as the label.

For example, a ratio of the frequency domain data corresponding to the pure audio sample to the frequency domain data corresponding to the mixed audio sample may be determined as the mask data for training.

In some application scenarios, a pure audio sample set and a noise sample set may be set. The pure audio sample may be selected from the pure audio sample set in various ways, and the noise sample may be selected from the noise sample set in various ways. Then, the selected pure audio sample and the selected noise sample are combined to obtain the mixed audio sample.

It should be noted that the sound processing model trained based on the intermediate processing results has relatively high processing accuracy. Therefore, the accuracy rate of the sound signal processing can be improved by using the processing method with the mask data as the intermediate processing result.

In some embodiments, the processing result may include pure frequency spectrum data. The pure frequency spectrum data may be frequency domain data corresponding to the pure audio data.

In some embodiments, the above step 102 may include: converting the pure frequency spectrum data into time domain data to obtain the pure audio data.

In some embodiments, the sound processing model of which the output includes the pure audio data may be trained in the following manner: obtaining a mixed audio sample; importing the mixed audio sample into an untrained sound processing model to generate candidate pure frequency spectrum data; generating a second loss value based on the pure frequency spectrum sample and the candidate pure frequency spectrum data; and adjusting a parameter of the untrained sound processing model based on the second loss value.

Here, a label of the mixed audio sample includes a pure frequency spectrum sample corresponding to a pure audio sample. For example, the pure frequency spectrum data may be obtained by performing time-frequency transform on the pure audio sample.

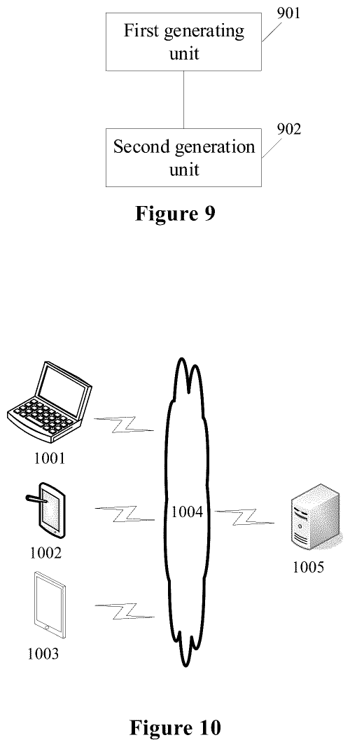

Further referring to FIG. 9, as an implementation of the methods shown in the above figures, a sound signal processing apparatus is provided according to an embodiment of the present disclosure. The apparatus embodiment corresponds to the method embodiment shown in FIG. 1. The apparatus is applicable to various electronic devices.

As shown in FIG. 9, the sound signal processing apparatus according to this embodiment includes: a first generation unit 901 and a second generation unit 902. The first generation unit is configured to import first frequency spectrum data corresponding to first audio data into a pre-trained sound processing module, to obtain a processing result. The second generation unit is configured to generate, based on the processing result, pure audio data corresponding to the first audio data. The sound processing model includes at least one preset convolution layer, and operations performed by using the preset convolution layer includes: performing, based on a first convolution kernel group, a convolution operation on a first sound spectrum feature map inputted into the preset convolution layer, to obtain a second sound spectrum feature map, where the number of the first convolution kernel group matches the number of the first sound spectrum feature map inputted into the preset convolution layer; and combining, based on a second convolution kernel group, the obtained second sound spectrum feature map, to obtain a third sound spectrum feature map corresponding to the second convolution kernel group, where the number of the second convolution kernel group matches the number of an output channel.

In this embodiment, for the processing of and the technical effects brought about by the first generation unit 901 and the second generation unit 902 of the sound signal processing device, reference can be made to the relevant descriptions of step 101 and step 102 in the corresponding embodiment of FIG. 1, which will not be repeated here.

In some embodiments, the first convolution kernel group includes at least two first convolution kernels, and the performing, based on a first convolution kernel group, a convolution operation on a first sound spectrum feature map inputted into the preset convolution layer, to obtain a second sound spectrum feature map includes: performing, according to a first correspondence, the convolution operation on the first sound spectrum feature map by using the first convolution kernels in the first convolution kernel group, to obtain the second sound spectrum feature map, where the first correspondence indicates a correspondence between the first convolution kernel and a frequency of the first sound spectrum feature map.

In some embodiments, the second convolution kernel group comprises at least two second convolution kernels, and the combining, based on a second convolution kernel group, the obtained second sound spectrum feature map, to obtain a third sound spectrum feature map corresponding to the second convolution kernel group includes: combining, according to a second correspondence, the obtained second sound spectrum feature map by using the second convolution kernels in the second convolution kernel group, to obtain the third sound spectrum feature map corresponding to the second convolution kernel group, where the second correspondence indicates a correspondence between the second convolution kernel and a frequency of the second sound spectrum feature map.

In some embodiments, the number of convolution kernels in the first convolution kernel group is determined according to a length of a frequency dimension of the first sound spectrum feature map and a first step size.

In some embodiments, a receptive field of a first convolution kernel is determined based on a candidate sampling position and a preset position offset parameter.

In some embodiments, the sound processing model includes at least one self-attention layer, and the self-attention layer is arranged subsequent to the at least one preset convolution layer, and an operation performed by using the self-attention layer includes: for each sound spectrum feature map output by the preset convolution layer, re-evaluate, based on a value of each position in the sound spectrum feature map and values of other positions in the sound spectrum feature map, the value of the position.

In some embodiments, the apparatus is applied to a terminal device, and the sound processing model is provided on the terminal device.

In some embodiments, the processing result includes mask data, and the generating, based on the processing result, pure audio data corresponding to the first audio data includes: generating second frequency spectrum data based on the mask data and the first frequency spectrum data; and converting the second frequency spectrum data into time domain data to obtain the pure audio data.

In some embodiments, the sound processing model is trained by: obtaining a mixed audio sample; importing the mixed audio sample into an untrained sound processing model to generate candidate mask data; generating a first loss value based on a label of the mixed audio sample and the candidate mask data; and adjusting, based on the first loss value, a parameter of the untrained sound processing model; where the label of the training sample is generated by performing time-frequency transformation on a pure audio sample and the mixed audio sample separately, generating mask data for training based on data obtained through the transformation, and determining the mask data for training as the label.

In some embodiments, the processing result includes pure frequency spectrum data, and the generating, based on the processing result, pure audio data corresponding to the first audio data includes: converting the pure frequency spectrum data into time domain data to obtain the pure audio data.

In some embodiments, the sound processing model is trained by: obtaining a mixed audio sample, where a label of the mixed audio sample includes a pure frequency spectrum sample corresponding to a pure audio sample; importing the mixed audio sample into an untrained sound processing model to generate candidate pure frequency spectrum data; generating a second loss value based on the pure frequency spectrum sample and the candidate pure frequency spectrum data; and adjusting a parameter of the untrained sound processing model based on the second loss value.

Reference is made to FIG. 10, which illustrates an exemplary system architecture in which the sound signal processing method according to an embodiment of the present disclosure is applicable.

As shown in FIG. 10, the system architecture may include terminal devices 1001, 1002, and 1003, a network 1004, and a server 1005. The network 1004 is a medium configured to provide a communication link between the terminal devices 1001, 1002, 1003 and the server 1005. The network 1004 may include various connection types, such as wired communication links, wireless communication links, or fiber optic cables, and the like.

The terminal devices 1001, 1002, 1003 may interact with the server 1005 through the network 1004 to receive or send messages and the like. Various client applications may be installed on the terminal devices 1001, 1002 and 1003, such as web browser applications, search applications, and news applications. The client applications in the terminal devices 1001, 1002, and 1003 may receive instructions from users, and perform corresponding functions according to the instructions from the users, such as adding information to another piece of information according to the instructions from the users.

The terminal devices 1001, 1002, and 1003 may be implemented by hardware or software. In a case that the terminal devices 1001, 1002, and 1003 are implemented by hardware, they may be various electronic devices that each has a display screen and supports web browsing, including but not limited to smart phones, tablet computers, e-book readers, MP3 (Moving Picture Experts Group Audio Layer III) players, MP4 (Moving Picture Experts Group Audio Layer IV) players, laptop portable computers, desktop computers, and the like. In a case that the terminal devices 1001, 1002, and 1003 are implemented by software, they may be installed in the electronic devices listed above. The terminal devices 1001, 1002, and 1003 each may be implemented as multiple software or software modules (for example, software or software modules for providing distributed services), or may be implemented as a single software or software module, which is not limited here.

The server 1005 may be a server that provides various services, for example, receiving information obtaining requests sent by the terminal devices 1001, 1002, and 1003, obtaining display information corresponding to the information obtaining requests in various ways in response to the information obtaining requests, and sending related data of the display information to the terminal devices 1001, 1002 and 1003.

It is to be noted that the sound signal processing method according to the embodiments of the present disclosure may be executed by a terminal device, and correspondingly, the sound signal processing apparatus may be provided in the terminal devices 1001, 1002, and 1003. In addition, the sound signal processing method according to the embodiments of the present disclosure may alternatively be executed by the server 1005, and correspondingly, the sound signal processing apparatus may be provided in the server 1005.

It should be understood that the numbers of terminal devices, the network and the server in FIG. 10 are merely illustrative. Any number of terminal devices, networks and servers may be provided according to implementation needs.

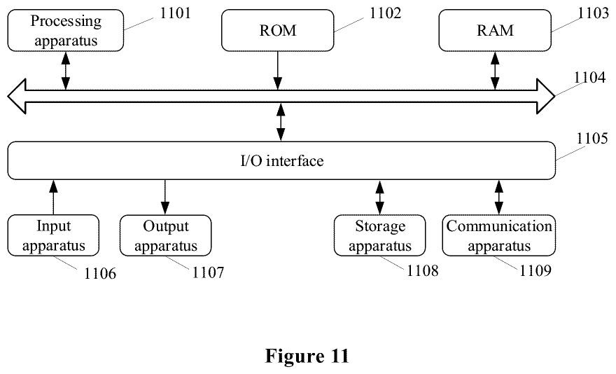

Reference is made to FIG. 11, which is a schematic structural diagram of an electronic device (for example, the terminal device or the server in FIG. 10) suitable for implementing the embodiments of the present disclosure. The terminal device in the embodiments of the present disclosure may include, but is not limited to, a mobile terminal such as a mobile phone, a notebook computer, a digital broadcast receiver, a PDA (a personal digital assistant), a PAD (a tablet), a PMP (a portable multimedia player), a vehicle-mounted terminal (for example, an in-vehicle navigation terminal), and the like, and a stationary terminal such as a digital TV, a desktop computer, and the like. The electronic device shown in FIG. 11 is only an example, and should not impose any limitation on the function and scope of use of the embodiments of the present disclosure.

As shown in FIG. 11, the electronic device may include a processing apparatus 1101, such as a central processing unit or a graphics processor, which can execute various appropriate actions and processes based on a program stored in a Read Only Memory (ROM) 1102 or a program loaded from a storage apparatus 1108 into a Random Access Memory (RAM) 1103. In the RAM 1103, various programs and data required by the electronic device 1100 for operation are further stored. The processing apparatus 1101, the ROM 1102, and the RAM 1103 are connected to each other through a bus 1104. An input/output (I/O) interface 1105 is also connected to the bus 1104.

Generally, the following may be connected to the I/O interface 1105: an input apparatus 1106 such as a touch screen, a touch pad, a keyboard, a mouse, a camera, a microphone, an accelerometer, a gyroscope, an output apparatus 1107 such as a Liquid Crystal Display (LCD), a speaker, a vibrator, a storage apparatus 1108 such as a magnetic tape, a hard disk, and a communication apparatus 1109. Based on the communication apparatus 1109, the electronic device may communicate with other devices through wired or wireless communication to exchange data. Although FIG. 11 shows the electronic device including various apparatuses, it should be understood that not all shown apparatuses are required to be implemented or included. The shown apparatuses may be replaced by other apparatuses, or more or less apparatuses may be included.

Specifically, the processes described with reference to flow charts, may be implemented as a computer software program according to an embodiment of the present disclosure. For example, a computer program product is provided according to an embodiment of the present disclosure, the computer program product includes a computer program embodied on a non-transitory computer readable medium. The computer program includes program codes for performing the method shown in the flowchart. In such embodiments, the computer program may be downloaded and installed from the network through the communication apparatus 1109, installed from the storage apparatus 1108, or installed from the ROM 1102. The computer program, when being executed by the processing apparatus 1101, performs functions defined in the method according to the embodiments of the present disclosure.

It should be noted that the computer readable medium according to the present disclosure may be a computer readable signal medium or a computer readable storage medium or any combination of the two. The computer readable storage medium may include, for example, but not limited to, an electronic, magnetic, optical, electromagnetic, infrared, or semiconductor system, apparatus, or device, or any combination of the foregoing. More particularly, the computer readable storage medium may include, but not limited to, an electrical connection having one or more wires, a portable computer diskette, a hard disk, a Random Access Memory (RAM), a Read Only Memory (ROM), an Erasable Programmable Read Only Memory (EPROM or a flash memory), an optical fiber, a portable Compact Disk Read-Only Memory (CD-ROM), an optical storage device, a magnetic storage device, or any suitable combination of the foregoing. In the present disclosure, the computer readable storage medium may be any tangible medium containing or storing a program, where the program may be used by an instruction execution system, apparatus or device or used in combination therewith. In the present disclosure, the computer readable signal medium may include a data signal transmitted in a baseband or transmitted as a part of a carrier wave. The data signal carries computer readable program codes. The transmitted data signal may have a variety of forms including, but not limited to, an electromagnetic signal, an optical signal, or any suitable combination of the above. The computer readable signal medium may also be any other computer readable medium except for the computer readable storage medium. The computer readable signal medium may send, transmit or transfer programs used by an instruction execution system, apparatus or device or used in combination therewith. The program codes included in the computer readable medium may be transferred through any proper medium including, but not limited to, an electric wire, an optical cable, RF (Radio Frequency), and the like, or any suitable combination of the foregoing.

In some embodiments, the client and the server may communicate with each other by using any currently known or future network protocol such as HTTP (HyperText Transfer Protocol) to communicate, and may be connected with a digital data network in any form or medium (such as a communication network). Examples of communication networks include a local area network (LAN), a wide area network (WAN), an internet (for example, the Internet), and a peer-to-peer network (such as the ad hoc peer-to-peer network), as well as any current or future networks.

The above mentioned computer-readable medium may be included in the above mentioned electronic device, or may exist alone without being assembled into the electronic device.

The above mentioned computer-readable medium carries one or more programs. The above mentioned one or more programs, when being executed by the electronic device, cause the electronic device to: import first frequency spectrum data corresponding to first audio data into a pre-trained sound processing module, to obtain a processing result, generate, based on the processing result, pure audio data corresponding to the first audio data. The sound processing model includes at least one preset convolution layer, and operations performed by using the preset convolution layer includes: performing, based on a first convolution kernel group, a convolution operation on a first sound spectrum feature map inputted into the preset convolution layer, to obtain a second sound spectrum feature map, where the number of the first convolution kernel group matches the number of the first sound spectrum feature map inputted into the preset convolution layer; and combining, based on a second convolution kernel group, the obtained second sound spectrum feature map, to obtain a third sound spectrum feature map corresponding to the second convolution kernel group, where the number of the second convolution kernel group matches the number of an output channel.

The computer program codes for performing the operations according to the present disclosure may be written in at least one programming language or a combination of the at least one programming language. The programming language includes, but is not limited to, an object oriented programming language such as Java, Smalltalk, C++ and a conventional procedural programming language such as “C” programming language or a programming language similar to “C” programming language. The program codes may be completely executed on a user computer, partially executed on the user computer, executed as a standalone software package, partially executed on the user computer and partially executed on a remote computer, completely executed on the remote computer or a server. In the cases relating to the remote computer, the remote computer may be connected to the user computer via any kind of networks including Local Area Network (LAN) or Wide Area Network (WAN), or the remote computer may be connected to an external computer (for example, via Internet provided by an Internet service provider).

The flowchart and block diagrams in the drawings illustrate the architecture, functionality, and operations of possible implementations of systems, methods and computer program products according to various embodiments of the present disclosure. In this regard, each block in the flowcharts or block diagrams may represent a module, program segment, or a portion of code that contains one or more executable instructions for implementing the specified logical functions. It should also be noted that, in some alternative implementations, the functions noted in the blocks may occur in an order other than the order shown in the drawings. For example, two blocks shown in succession may be executed substantially concurrently, or the blocks may sometimes be executed in the reverse order, depending upon the functionality involved. It is also noted that each block of the block diagrams and/or flowchart illustrations, and combinations of blocks in the block diagrams and/or flowchart illustrations, may be implemented in dedicated hardware-based systems that perform the specified functions or operations, or may be implemented by a combination of dedicated hardware and computer instructions.

The modules involved in the embodiments of the present disclosure may be implemented in a software manner, or in a hardware manner. The name of the modules does not constitute a limitation of the modules under any circumstances. For example, the first generation unit may alternatively referred to as “a unit for generating a processing result”.

The functions described above may be performed, at least in part, by one or more hardware logic components. For example, without limitation, examples of hardware logic components that may be used include: a Field Programmable Gate Array (FPGA), a Application Specific Integrated Circuit (ASIC), an Application Specific Standard Product (ASSP), a System on Chip (SOC), a Complex Programmable Logical Device (CPLD) and the like.

In the present disclosure, a machine-readable medium may be a tangible medium that may contain or store a program for use by or in connection with the instruction execution system, apparatus or device. The machine-readable medium may be a machine-readable signal medium or a machine-readable storage medium. Machine-readable media may include, but are not limited to, electronic, magnetic, optical, electromagnetic, infrared, or semiconductor systems, apparatuses, or devices, or any suitable combination of the foregoing. More specific examples of machine-readable storage media include one or more wire-based electrical connections, a portable computer disk, a hard disk, a Random Access Memory (RAM), a Read Only Memory (ROM), an Erasable Programmable Read Only Memory (EPROM or a flash memory), a optical fiber, a Compact Disk Read Only Memory (CD-ROM), an optical storage device, a magnetic storage device, or any suitable combination of the foregoing.

According to one or more embodiments of the present disclosure, the number of the first convolution kernel group matches the number of the first sound spectrum feature map inputted into the preset convolution layer, and the number of the second convolution kernel group matches the number of an output channel.

According to one or more embodiments of the present disclosure, the first convolution kernel group includes at least two first convolution kernels, and the performing, based on a first convolution kernel group, a convolution operation on a first sound spectrum feature map inputted into the preset convolution layer, to obtain a second sound spectrum feature map includes: performing, according to a first correspondence, the convolution operation on the first sound spectrum feature map by using the first convolution kernels in the first convolution kernel group, to obtain the second sound spectrum feature map, where the first correspondence indicates a correspondence between the first convolution kernel and a frequency of the first sound spectrum feature map.

According to one or more embodiments of the present disclosure, the second convolution kernel group includes at least two second convolution kernels, and the combining, based on a second convolution kernel group, the obtained second sound spectrum feature map, to obtain a third sound spectrum feature map corresponding to the second convolution kernel group includes: combining, according to a second correspondence, the obtained second sound spectrum feature map by using the second convolution kernels in the second convolution kernel group, to obtain the third sound spectrum feature map corresponding to the second convolution kernel group, where the second correspondence indicates a correspondence between the second convolution kernel and a frequency of the second sound spectrum feature map.

According to one or more embodiments of the present disclosure, the number of convolution kernels in the first convolution kernel group is determined according to a length of a frequency dimension of the first sound spectrum feature map and a first step size.

According to one or more embodiments of the present disclosure, a receptive field of the first convolution kernel is determined based on a candidate sampling position and a preset position offset parameter.

According to one or more embodiments of the present disclosure, the sound processing model includes at least one self-attention layer, and the self-attention layer is arranged subsequent to the at least one preset convolution layer, and an operation performed by using the self-attention layer includes: for each sound spectrum feature map output by the preset convolution layer, re-evaluating, based on a value of each position in the sound spectrum feature map and values of other positions in the sound spectrum feature map, the value of the position.

According to one or more embodiments of the present disclosure, the method according to the present disclosure is applied to a terminal device, and the sound processing model is provided on the terminal device.

According to one or more embodiments of the present disclosure, the processing result includes mask data, and the generating, based on the processing result, pure audio data corresponding to the first audio data includes: generating second frequency spectrum data based on the mask data and the first frequency spectrum data; and converting the second frequency spectrum data into time domain data to obtain the pure audio data.

According to one or more embodiments of the present disclosure, the sound processing model is trained by: obtaining a mixed audio sample; importing the mixed audio sample into an untrained sound processing model to generate candidate mask data; generating a first loss value based on a label of the mixed audio sample and the candidate mask data; and adjusting, based on the first loss value, a parameter of the untrained sound processing model; where the label of the training sample is generated by performing time-frequency transformation on a pure audio sample and the mixed audio sample separately, generating mask data for training based on data obtained through the transformation, and determining the mask data for training as the label.

According to one or more embodiments of the present disclosure, the processing result includes pure frequency spectrum data, and the generating, based on the processing result, pure audio data corresponding to the first audio data includes: converting the pure frequency spectrum data into time domain data to obtain the pure audio data.

According to one or more embodiments of the present disclosure, the sound processing model is trained by: obtaining a mixed audio sample, where a label of the mixed audio sample includes a pure frequency spectrum sample corresponding to a pure audio sample; importing the mixed audio sample into an untrained sound processing model to generate candidate pure frequency spectrum data; generating a second loss value based on the pure frequency spectrum sample and the candidate pure frequency spectrum data; and adjusting a parameter of the untrained sound processing model based on the second loss value.

According to one or more embodiments of the present disclosure, a sound signal processing apparatus is provided, including: a first generation unit configured to import first frequency spectrum data corresponding to first audio data into a pre-trained sound processing module, to obtain a processing result; and a second generation unit is configured to generate, based on the processing result, pure audio data corresponding to the first audio data. The sound processing model includes at least one preset convolution layer, and operations performed by using the preset convolution layer includes: performing, based on a first convolution kernel group, a convolution operation on a first sound spectrum feature map inputted into the preset convolution layer, to obtain a second sound spectrum feature map; and combining, based on a second convolution kernel group, the obtained second sound spectrum feature map, to obtain a third sound spectrum feature map corresponding to the second convolution kernel group.

According to one or more embodiments of the present disclosure, the first convolution kernel group includes at least two first convolution kernels, and the performing, based on a first convolution kernel group, a convolution operation on a first sound spectrum feature map inputted into the preset convolution layer, to obtain a second sound spectrum feature map includes: performing, according to a first correspondence, the convolution operation on the first sound spectrum feature map by using the first convolution kernels in the first convolution kernel group, to obtain the second sound spectrum feature map, where the first correspondence indicates a correspondence between the first convolution kernel and a frequency of the first sound spectrum feature map.

According to one or more embodiments of the present disclosure, the second convolution kernel group includes at least two second convolution kernels, and the combining, based on a second convolution kernel group, the obtained second sound spectrum feature map, to obtain a third sound spectrum feature map corresponding to the second convolution kernel group includes: combining, according to a second correspondence, the obtained second sound spectrum feature map by using the second convolution kernels in the second convolution kernel group, to obtain the third sound spectrum feature map corresponding to the second convolution kernel group, where the second correspondence indicates a correspondence between the second convolution kernel and a frequency of the second sound spectrum feature map.

According to one or more embodiments of the present disclosure, the number of convolution kernels in the first convolution kernel group is determined according to a length of a frequency dimension of the first sound spectrum feature map and a first step size.

According to one or more embodiments of the present disclosure, a receptive field of the first convolution kernel is determined based on a candidate sampling position and a preset position offset parameter.

According to one or more embodiments of the present disclosure, the sound processing model includes at least one self-attention layer, and the self-attention layer is arranged subsequent to the at least one preset convolution layer, and an operation performed by using the self-attention layer includes: for each sound spectrum feature map output by the preset convolution layer, re-evaluating, based on a value of each position in the sound spectrum feature map and values of other positions in the sound spectrum feature map, the value of the position.

According to one or more embodiments of the present disclosure, the apparatus according to the present disclosure is applied to a terminal device, and the sound processing model is provided on the terminal device.

According to one or more embodiments of the present disclosure, the processing result includes mask data, and the generating, based on the processing result, pure audio data corresponding to the first audio data includes: generating second frequency spectrum data based on the mask data and the first frequency spectrum data; and converting the second frequency spectrum data into time domain data to obtain the pure audio data.

According to one or more embodiments of the present disclosure, the sound processing model is trained by: obtaining a mixed audio sample; importing the mixed audio sample into an untrained sound processing model to generate candidate mask data; generating a first loss value based on a label of the mixed audio sample and the candidate mask data; and adjusting, based on the first loss value, a parameter of the untrained sound processing model; where the label of the training sample is generated by performing time-frequency transformation on a pure audio sample and the mixed audio sample separately, generating mask data for training based on data obtained through the transformation, and determining the mask data for training as the label.

According to one or more embodiments of the present disclosure, the processing result includes pure frequency spectrum data, and the generating, based on the processing result, pure audio data corresponding to the first audio data includes: converting the pure frequency spectrum data into time domain data to obtain the pure audio data.

According to one or more embodiments of the present disclosure, the sound processing model is trained by: obtaining a mixed audio sample, where a label of the mixed audio sample includes a pure frequency spectrum sample corresponding to a pure audio sample; importing the mixed audio sample into an untrained sound processing model to generate candidate pure frequency spectrum data; generating a second loss value based on the pure frequency spectrum sample and the candidate pure frequency spectrum data; and adjusting a parameter of the untrained sound processing model based on the second loss value.

According to one or more embodiments of the present disclosure, an electronic device is provided, including: one or more processors; and a storage device configured to store one or more programs, where the one or more programs, when executed by the one or more processors, cause the one or more processors to implement the method according to any one of the embodiments of the present disclosure.

According to one or more embodiments of the present disclosure, a computer-readable medium, on which a computer program is stored is provided, where the program is configured to implement the method according to any one of the embodiments of the present disclosure when executed by a processor.

The above description includes merely preferred embodiments of the present disclosure and explanations of technical principles used. Those skilled in the art should understand that the scope of the present disclosure is not limited to technical solutions formed by a specific combination of the above technical features, but covers other technical solutions formed by any combination of the above technical features or equivalent features thereof without departing from the concept of the present disclosure. For example, a technical solution formed by interchanging the above features with technical features having similar functions as disclosed (but not limited thereto) is also covered in the scope of the present disclosure.

In addition, although the operations are described in a specific order, it should not be understood that these operations are to be performed in the specific order shown or performed in a sequential order. Under certain circumstances, multitasking and parallel processing may be advantageous. Although the specific implementation details are described above, these implementation details should not be construed as limiting the scope of the present disclosure. The features described in multiple separate embodiments may be implemented in combination in a separate embodiment. Conversely, the features described in a separate embodiment may be implemented in multiple embodiments individually or in any suitable sub-combination.

Although the subject matter has been described in language specific to structural features and/or logical actions of the method, it should be understood that the subject matter defined in the appended claims are unnecessarily limited to the specific features or actions described above. The specific features and actions described above are merely exemplary forms of implementing the claims.

1. A sound signal processing method, comprising:
importing first frequency spectrum data corresponding to first audio data into a pre-trained sound processing model to obtain a processing result; and
generating, based on the processing result, pure audio data corresponding to the first audio data, wherein
the sound processing model comprises at least one preset convolution layer, and
operations performed by using the preset convolution layer comprises:
performing, based on a first convolution kernel group, a convolution operation on a first sound spectrum feature map inputted into the preset convolution layer, to obtain a second sound spectrum feature map; and
combining, based on a second convolution kernel group, the obtained second sound spectrum feature map, to obtain a third sound spectrum feature map corresponding to the second convolution kernel group.

2. The method according to claim 1, wherein a number of the first convolution kernel group matches a number of the first sound spectrum feature map inputted into the preset convolution layer, and a number of the second convolution kernel group matches a number of an output channel.

3. The method according to claim 1, wherein
the first convolution kernel group comprises at least two first convolution kernels, and
the performing, based on a first convolution kernel group, a convolution operation on a first sound spectrum feature map inputted into the preset convolution layer, to obtain a second sound spectrum feature map comprises:
performing, according to a first correspondence, the convolution operation on the first sound spectrum feature map by using the first convolution kernels in the first convolution kernel group, to obtain the second sound spectrum feature map,
wherein the first correspondence indicates a correspondence between the first convolution kernel and a frequency of the first sound spectrum feature map.

4. The method according to claim 1, wherein
the second convolution kernel group comprises at least two second convolution kernels, and
the combining, based on a second convolution kernel group, the obtained second sound spectrum feature map, to obtain a third sound spectrum feature map corresponding to the second convolution kernel group comprises:
combining, according to a second correspondence, the obtained second sound spectrum feature map by using the second convolution kernels in the second convolution kernel group, to obtain the third sound spectrum feature map corresponding to the second convolution kernel group,
wherein the second correspondence indicates a correspondence between the second convolution kernel and a frequency of the second sound spectrum feature map.

5. The method according to claim 1, wherein a number of convolution kernels in the first convolution kernel group is determined according to a length of a frequency dimension of the first sound spectrum feature map and a first step size.

6. The method according to claim 1, wherein a receptive field of a first convolution kernel is determined based on a candidate sampling position and a preset position offset parameter.

7. The method according to claim 1, wherein
the sound processing model comprises at least one self-attention layer, and the self-attention layer is arranged subsequent to the at least one preset convolution layer, and
an operation performed by using the self-attention layer comprises:
for each sound spectrum feature map output by the preset convolution layer, re-evaluate, based on a value of each position in the sound spectrum feature map and values of other positions in the sound spectrum feature map, the value of the position.

8. The method according to claim 1, wherein the method is applied to a terminal device, and the sound processing model is provided on the terminal device.

9. The method according to any claim 1, wherein
the processing result comprises mask data, and
the generating, based on the processing result, pure audio data corresponding to the first audio data comprises:
generating second frequency spectrum data based on the mask data and the first frequency spectrum data; and
converting the second frequency spectrum data into time domain data to obtain the pure audio data.

10. The method according to claim 9, wherein the sound processing model is trained by:
obtaining a mixed audio sample;
importing the mixed audio sample into an untrained sound processing model to generate candidate mask data;
generating a first loss value based on a label of the mixed audio sample and the candidate mask data; and
adjusting, based on the first loss value, a parameter of the untrained sound processing model;
wherein the label of the mixed audio sample is generated by performing time-frequency transformation on a pure audio sample and the mixed audio sample separately, generating mask data for training based on data obtained through the transformation, and determining the mask data for training as the label.

11. The method according to claim 1, wherein
the processing result comprises pure frequency spectrum data, and
the generating, based on the processing result, pure audio data corresponding to the first audio data comprises:
converting the pure frequency spectrum data into time domain data to obtain the pure audio data.

12. The method according to claim 11, wherein the sound processing model is trained by:
obtaining a mixed audio sample, wherein a label of the mixed audio sample includes a pure frequency spectrum sample corresponding to a pure audio sample;
importing the mixed audio sample into an untrained sound processing model to generate candidate pure frequency spectrum data;
generating a second loss value based on the pure frequency spectrum sample and the candidate pure frequency spectrum data; and
adjusting a parameter of the untrained sound processing model based on the second loss value.

13. (canceled)

14. An electronic device, comprising:
at least one processor; and
a storage device configured to store at least one program, wherein
the at least one program, when executed by the at least one processor, causes the at least one processor to:
import first frequency spectrum data corresponding to first audio data into a pre-trained sound processing model to obtain a processing result; and
generate, based on the processing result, pure audio data corresponding to the first audio data, wherein
the sound processing model comprises at least one preset convolution layer, and operations performed by using the preset convolution layer comprises:
performing, based on a first convolution kernel group, a convolution operation on a first sound spectrum feature map inputted into the preset convolution layer, to obtain a second sound spectrum feature map; and
combining, based on a second convolution kernel group, the obtained second sound spectrum feature map, to obtain a third sound spectrum feature map corresponding to the second convolution kernel group.

15. A non-transitory computer-readable medium, on which a computer program is stored, wherein the program is configured to:
import first frequency spectrum data corresponding to first audio data into a pre-trained sound processing model to obtain a processing result; and
generate, based on the processing result, pure audio data corresponding to the first audio data, wherein
the sound processing model comprises at least one preset convolution layer, and operations performed by using the preset convolution layer comprises:
performing, based on a first convolution kernel group, a convolution operation on a first sound spectrum feature map inputted into the preset convolution layer, to obtain a second sound spectrum feature map; and
combining, based on a second convolution kernel group, the obtained second sound spectrum feature map, to obtain a third sound spectrum feature map corresponding to the second convolution kernel group.

16. The electronic device of claim 14, wherein a number of the first convolution kernel group matches a number of the first sound spectrum feature map inputted into the preset convolution layer, and a number of the second convolution kernel group matches a number of an output channel.

17. The electronic device of claim 14, wherein
the first convolution kernel group comprises at least two first convolution kernels, and
the performing, based on a first convolution kernel group, a convolution operation on a first sound spectrum feature map inputted into the preset convolution layer, to obtain a second sound spectrum feature map comprises:
performing, according to a first correspondence, the convolution operation on the first sound spectrum feature map by using the first convolution kernels in the first convolution kernel group, to obtain the second sound spectrum feature map,
wherein the first correspondence indicates a correspondence between the first convolution kernel and a frequency of the first sound spectrum feature map.

18. The electronic device of claim 14, wherein
the second convolution kernel group comprises at least two second convolution kernels, and
the combining, based on a second convolution kernel group, the obtained second sound spectrum feature map, to obtain a third sound spectrum feature map corresponding to the second convolution kernel group comprises:
combining, according to a second correspondence, the obtained second sound spectrum feature map by using the second convolution kernels in the second convolution kernel group, to obtain the third sound spectrum feature map corresponding to the second convolution kernel group,
wherein the second correspondence indicates a correspondence between the second convolution kernel and a frequency of the second sound spectrum feature map.

19. The electronic device of claim 14, wherein a number of convolution kernels in the first convolution kernel group is determined according to a length of a frequency dimension of the first sound spectrum feature map and a first step size.

20. The electronic device of claim 14, wherein a receptive field of a first convolution kernel is determined based on a candidate sampling position and a preset position offset parameter.

21. The electronic device of claim 14, wherein
the sound processing model comprises at least one self-attention layer, and the self-attention layer is arranged subsequent to the at least one preset convolution layer, and
an operation performed by using the self-attention layer comprises:
for each sound spectrum feature map output by the preset convolution layer, re-evaluate, based on a value of each position in the sound spectrum feature map and values of other positions in the sound spectrum feature map, the value of the position.
